(19) United States
(12) Patent Application Publication
(10) Pub. No.: US 2008/0068178 A1
(43) Pub. Date: Mar. 20, 2008

(54) Closure and container package with RFID circuit

(75) Inventor: Todd W. Meyer, Ottawa, OH (US)

Correspondence Address: OWENS-ILLINOIS, INC., ONE MICHAEL OWENS WAY, THREE O-I PLAZA, PERRYSBURG, OH, 43551-2999, US

(73) Assignee: Owens-Illinois HealthCare Packaging, Inc.

(21) Appl. No.: 11/516,999

(22) Filed: Sep. 7, 2006

(51) Int. Cl. G08B 13/14

(52) U.S. Cl. 340/572.8

(57) ABSTRACT

A package includes a container and a closure secured to a neck finish of the container. An RFID circuit is disposed on the package, and includes an RFID tag on the closure and an RFID antenna on the container. The RFID tag and antenna are so disposed on the closure and the container that the tag makes electrical contact with the antenna to complete the RFID circuit when the closure is applied to the container neck finish. The RFID tag preferably is molded into or mounted on an inside surface of the closure, and the RFID antenna preferably is molded into or mounted on an external surface of the container neck finish. In various exemplary embodiments of the disclosure, the RFID tag is mounted on an inside surface of the closure skirt, an inside surface of the closure base wall or an inside surface of a liner disk within the closure, and the RFID antenna is molded into or mounted on an outside surface of the container neck finish or an end surface of the container neck finish.

The present disclosure relates to placement of a radio frequency identification (RFID) circuit on a closure and container package for identification or other purposes, and to a closure and a container for such a package.

### BACKGROUND AND SUMMARY OF THE DISCLOSURE

A general object of the present disclosure is to provide a package that includes a closure, a container, and an RFID circuit in which an RFID tag is disposed on the closure and an RFID antenna is disposed on the container in such a way that the RFID tag and antenna make electrical contact when the closure is applied to the container.

The present disclosure embodies a number of aspects that can be implemented separately from or in combination with each other.

A package in accordance with one aspect of the present disclosure includes a container and a closure secured to a neck finish of the container. An RFID circuit is disposed on the package, and includes an RFID tag on the closure and an RFID antenna on the container. The RFID tag and antenna are so disposed on the closure and the container that the tag makes electrical contact with the antenna to complete the RFID circuit when the closure is applied to the container neck finish. The RFID tag preferably is molded into or mounted on an inside surface of the closure, and the RFID antenna preferably is molded into or mounted on an external surface of the container neck finish. In various exemplary embodiments of the disclosure, the RFID tag is mounted on an inside surface of the closure skirt, an inside surface of the closure base wall or an inside surface of a liner disk within the closure, and the RFID antenna is molded into or mounted on an outside surface of the container neck finish or an end surface of the container neck finish.

### BRIEF DESCRIPTION OF THE DRAWINGS

The disclosure, together with additional objects, features, advantages and aspects thereof, will best be understood from the following description, the appended claims and the accompanying drawings, in which:

FIG. 1 is a fragmentary sectional view of a package in accordance with a first exemplary embodiment of the present disclosure;

FIG. 2 is a fragmentary sectional view of a package in accordance with a second exemplary embodiment of the present disclosure;

FIG. 3 is a top plan view of the end surface of the container neck finish in the package of FIG. 2;

FIG. 4 is an inside plan view of the closure in the package of FIG. 2; and

FIG. 5 is a fragmentary sectional view of a package in accordance with a third exemplary embodiment of the present disclosure.

### DETAILED DESCRIPTION OF PREFERRED EMBODIMENTS

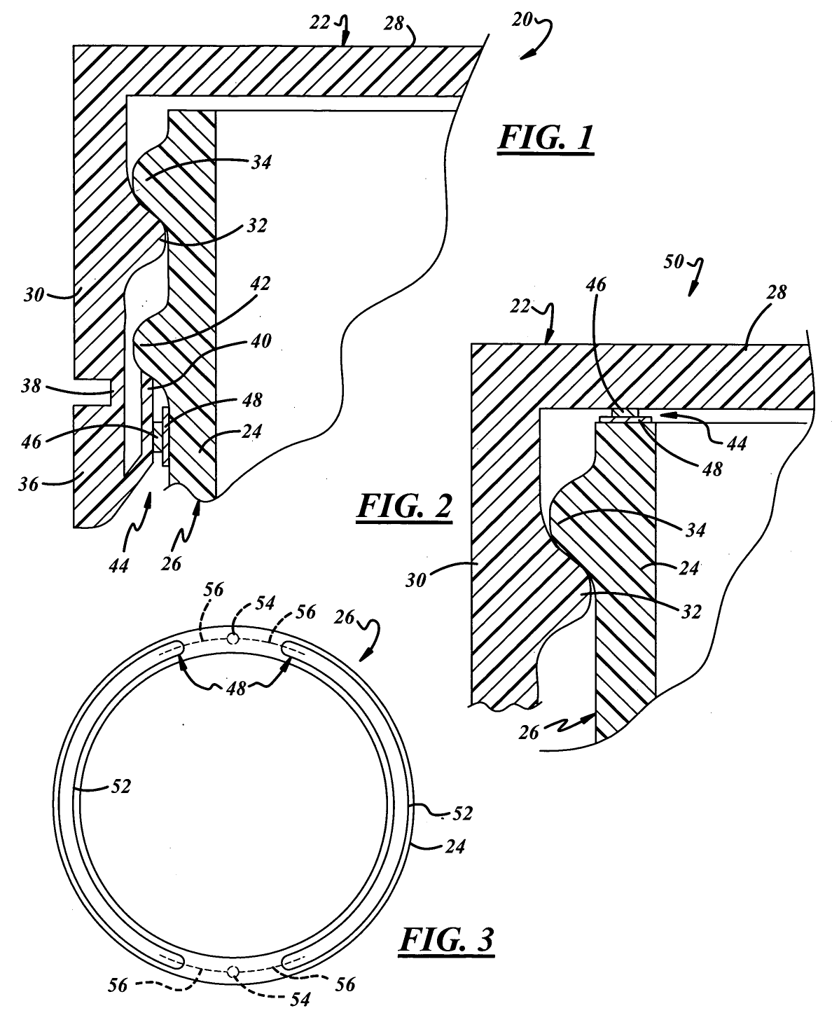

FIG. 1 illustrates a package 20 in accordance with one exemplary embodiment of the present disclosure. Package 20 includes a closure 22 applied to the neck finish 24 of a container 26. Container 26 may be of glass or plastic construction. Closure 22 preferably is of molded plastic construction and includes a shell having a base wall 28 and a skirt 30 with one or more internal thread segments 32 for engagement with one or more external thread segments 34 on neck finish 24 to secure closure 22 to container 26. (The term “thread segments” is employed in its usual broad sense to include both continuous and discontinuous threads, and both single and multiple threads on the container neck finish.) Skirt 30 includes a tamper band 36 frangibly connected by one or more frangible bridges or webs 38. Tamper band 36 may be of any suitable geometry, with the geometry illustrated in FIG. 1 being exemplary. A stop flange 40 preferably extends upwardly and inwardly from tamper band 36 for engagement with an external bead 42 on neck finish 24. When closure 22 is first removed from neck finish 24, abutment of stop flange 40 with bead 42 limits movement of band 36 so that band 36 becomes separated from skirt 30 by fracture of bridges or webs 38 to indicate that the package has been opened. Closure 22 may include additional elements, such as one or more sealing elements, either integral with or separate from the closure shell, for sealing engagement with the container neck finish.

An RFID circuit 44 is provided on package 20. Circuit 44 in this embodiment includes an RFID tag 46 molded into or mounted on an inside surface of tamper band 36, preferably on the inside surface of stop flange 40, and an RFID antenna 48 molded into or mounted on an outside surface of neck finish 24 beneath bead 42. When closure 22 is initially fully applied to neck finish 24 (after placement of product within container 26), RFID tag 46 is brought into electrical contact with RFID antenna 48, preferably both physical and electrical contact as illustrated in FIG. 1. Such contact completes RFID circuit 44 so that RFID tag 46 can be interrogated by external circuitry through antenna 48. However, when closure 22 is removed from neck finish 24 and tamper band 46 is frangibly severed from the rest of skirt 30, the physical and electrical contact between RFID tag 46 and RFID antenna 48 is broken because tamper band 36 has been rotated on neck finish 24 and falls away from the position illustrated in FIG. 1. Thus, opening of the package is indicated both by physical separation of tamper band 36 from the remainder of skirt 30 and by the absence of a complete RFID circuit upon interrogation.

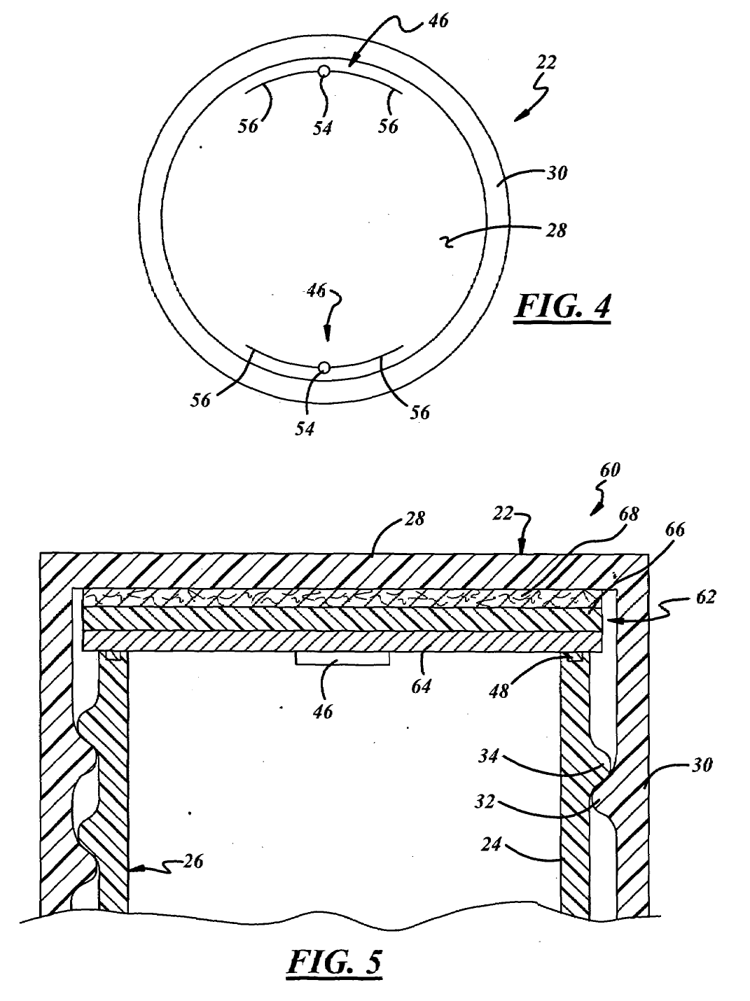

FIGS. 2-4 illustrate a package 50 in accordance with a second exemplary embodiment of the disclosure. Elements in FIGS. 2-4 (and FIG. 5) that are similar to those illustrated in FIG. 1 and discussed above are indicated by correspondingly identical reference numerals. In package 50, RFID circuit 44 includes an RFID tag 46 molded into or mounted on the undersurface of closure base wall 28 and an RFID antenna 48 molded into or mounted on the end surface of container neck finish 24. Antenna 48 can include one or more segments 52 (FIG. 3) on the end surface of neck finish 24. RFID tag 46 may include one or more integrated circuits 54 (FIG. 4) and connection straps 56 molded into or mounted on base wall 28 so that connection straps 56 make electrical contact, preferably both physical and electrical contact, with antenna segments 52 when closure 22 is fully applied to the container neck finish. (Circuits 54 and connection straps 56 are illustrated in phantom in FIG. 3 at their superimposed positions relative to antenna segments 52 when closure 22 is fully applied to neck finish 24.) The embodiment of FIGS. 2-4 has the advantage that the RFID circuit is operable after the package has been opened as long as the closure is fully reapplied to the container neck finish. Tamper indication can be provided by other means, such as by means of a frangible tamper band 36 (FIG. 1), although RFID circuit 44 will be broken and provide tamper indication if the closure is partially removed from the container neck finish.

FIG. 5 illustrates a package 60 in accordance with a third exemplary embodiment of the disclosure. Package 60 includes a liner disk 62 disposed within closure 22 for sealing engagement with the end surface of container neck finish 24. RFID antenna 48 is molded into the end surface of neck finish 24, and RFID tag 46 is mounted on a metal foil layer 64 of liner 62 for physical and electrical contact with antenna 48 when closure 22 is fully applied to neck finish 24. Foil layer 62 may be induction or conduction welded to the end surface of neck finish 24, which may evaporate layer 66 of liner 62, leaving layer 68 overlying metal foil layer 64. In such an application, closure 22 would be removed from neck finish 24 and foil layer 64 torn and removed by a user to obtain access to the product within the package, which would simultaneously rupture the electrical connection between RFID tag 46 and antenna 48 providing both a physical and an interrogatable indication that the package has been opened.

There thus have been disclosed a package, a closure and a container that fully satisfy all of the objects and aims previously set forth. The disclosure has been presented in connection with several exemplary embodiments, and additional modifications and variations have been discussed. Other modifications and variations readily will suggest themselves to persons of ordinary skill in the art in view of the foregoing discussion. The disclosure is intended to embrace all such modifications and variations as fall within the spirit and broad scope of the appended claims.

1. A package that includes a container, a closure secured to a neck finish of said container, and an RFID circuit on said package and which includes an RFID tag on said closure and an RFID antenna on said container, said tag and said antenna being so disposed on said closure and said container that said tag makes electrical contact with said antenna to complete said RFID circuit when said closure is applied to said container neck finish.

2. The package set forth in claim 1 wherein said closure includes a skirt for securing said closure to said neck finish and said RFID tag is disposed on an inside of said skirt.

3. The closure set forth in claim 2 wherein said skirt includes a frangibly connected tamper band and said RFID tag is on an inside surface of said tamper band.

4. The package set forth in claim 2 wherein said antenna is on an outside surface of said neck finish.

5. The package set forth in claim 1 wherein said closure includes a base wall and said RFID tag is disposed on an inside surface of said base wall.

6. The package set forth in claim 5 wherein said antenna is on an end surface of said neck finish.

7. The package set forth in claim 1 wherein said closure includes a liner disk and said RFID tag is on said liner disk.

8. The package set forth in claim 7 wherein said antenna is on an end surface of said neck finish.

9. The package set forth in claim 1 wherein said RFID tag is molded into or mounted on said closure, and said RFID antenna is molded into or mounted on said neck finish.

10. A package that includes a container having a neck finish, a plastic closure having a skirt externally secured to said neck finish and an RFID circuit on said package,
said RFID circuit including an RFID tag molded into or mounted on an inside surface of said closure and an RFID antenna molded into or mounted on an outside surface of said neck finish so that said RFID tag makes physical and electrical contact with said RFID antenna when said closure is applied to said neck finish.

11. The package set forth in claim 10 wherein said RFID tag is on an inside surface of said skirt and said antenna is on a side surface of said neck finish.

12. The package set forth in claim 11 wherein said skirt includes a frangibly connected tamper band and said RFID tag is on an inside surface of said tamper band.

13. The package set forth in claim 10 wherein said closure includes a base wall, said RFID tag is disposed on an inside surface of said base wall, and said antenna is on an end surface of said neck finish.

14. The package set forth in claim 10 wherein said closure includes a liner disk, said RFID tag is on said liner disk, and said antenna is on an end surface of said neck finish.

15. A molded plastic container having a neck finish and an RFID antenna molded into or mounted on an outside surface of said neck finish in such a way as to make physical and electrical contact with an RFID tag on a closure when the closure is applied to said neck finish.

16. The container set forth in claim 15 wherein said antenna is on a side surface of said neck finish.

17. The container set forth in claim 15 wherein said antenna is on an end surface of said neck finish.

18. A closure that includes a plastic shell and an RFID tag molded into or mounted on an inside surface of said shell for making physical and electrical contact with an RFID antenna on a container neck finish when said closure is applied to the neck finish.

19. The closure set forth in claim 18 including a skirt for securing said closure to a container neck finish, wherein said RFID tag is disposed on an inside surface of said skirt.

20. The closure set forth in claim 19 wherein said skirt includes a frangibly connected tamper band and said RFID tag is molded into or mounted on an inside surface of said tamper band.

21. The closure set forth in claim 18 wherein said closure shell includes a base wall and said RFID tag is molded into or mounted on an inside surface of said base wall.
